(19) United States
(12) Patent Application Publication
(10) Pub. No.: US 2016/0023444 A1
(43) Pub. Date: Jan. 28, 2016

(54) TRANSPARENT CONDUCTIVE FILM

(71) Applicant: NAGAOKA SANGYOU CO., LTD., Shiga (JP)

(72) Inventors: Nario UEJUKKOKU, Shiga (JP); Toshinori NAGAOKA, Shiga (JP)

(21) Appl. No.: 14/874,567

(22) Filed: Oct. 5, 2015

Related U.S. Application Data
(63) Continuation of application No. PCT/JP2014/057395, filed on Mar. 18, 2014.

(30) Foreign Application Priority Data
Apr. 9, 2013 (JP) 2013-081211

(51) Int. Cl. B32B 27/08; G06F 3/044; G06F 3/041

(52) U.S. Cl. CPC B32B 27/08; G06F 3/041; G06F 3/044; B32B 2307/412; B32B 2457/20; B32B 2307/202; G06F 2203/04107

(57) ABSTRACT

A transparent conductive film includes a substrate with transparency and flexibility, and a conductive layer arranged on at least one surface of the substrate, the conductive layer comprising a conductive resin. The conductive layer has a surface with a center-line average roughness Ra75 of 0.002 to 0.02 μm inclusive, a maximum height Rz of 0.03 to 0.10 μm inclusive, and a ten-spot average roughness RzJIS94 of 0.02 to 0.05 μm inclusive.

### CROSS-REFERENCE TO RELATED APPLICATIONS

This application is a continuation application of International Patent Application No. PCT/JP2014/057395 filed on Mar. 18, 2014, which claims priority to Japanese Patent Application No. 2013-081211 Filed on Apr. 9, 2013, the entire contents of which are incorporated by reference in their entirety herein.

### BACKGROUND OF INVENTION

1. Field of the Invention

The present invention relates to transparent conductive films for electrodes and substrates in capacitive sensors including capacitive touch panels or in organic EL devices.

2. Background Art

Touch panels for mobile information terminals and automatic transaction apparatuses use a conductive film or a conductive sheet that is conductive and transparent (hereafter referred to as a “transparent conductive film”) as a sensor for detecting press by a user's finger. Such transparent conductive films having conductivity and transparency now find use in solar panels, organic electroluminescence (EL) displays, and LED illuminations, in addition to their use in touch panels.

A transparent conductive film may include a synthetic resin film or sheet on which a conductive layer of indium tin oxide is formed to provide conductivity. Another transparent conductive film may include a synthetic resin film or sheet coated with a conductive layer, which may be formed using inorganic particles, such as nano metal particles, metal nanowires, or carbon nanotubes, dispersed in a resin binder.

However, press by a user's finger on a transparent conductive film in a touch panel for example may generate Newton's rings, or fringes, which can lower the visibility of the touch panel. Techniques have been developed to regulate the surface roughness of the conductive layer to reduce such Newton's rings.

For example, the surface of a transparent conductive film described in Japanese Unexamined Patent Application Publication No. 2007-103348 (Patent Literature 1) has a center-line average roughness (Ra) within a range of 0.11 to 0.18 μm, a maximum height (Ry) within a range of 0.9 to 1.6 μm, and an average interval between local peaks (S) within a range of 0.05 to 0.11 mm) to reduce Newton's rings.

However, many recent mobile information terminals include a reinforced glass plate or a hard coat film, via which a transparent conductive film is pressed by a finger. This accelerates the trend toward transparent conductive films with higher conductivity. Additionally, touch panels are now designed to display higher quality images and videos and clearer characters with higher resolution. This accelerates the trend toward transparent conductive films with higher transparency.

Although the transparent conductive film described in Patent Literature 1 reduces Newton's rings to achieve visibility, this transparent conductive film is not designed to have such higher transparency and may not reflect the trend.

### SUMMARY OF INVENTION

One or more aspects of the present invention are directed to a transparent conductive film with both higher conductivity and higher transparency.

One aspect of the present invention provides a transparent conductive film including a substrate with transparency and flexibility, and a conductive layer arranged on at least one surface of the substrate. The conductive layer includes a conductive resin. The conductive layer has a surface with a center-line average roughness Ra₇₅ of 0.002 to 0.02 μm inclusive, a maximum height Rz of 0.03 to 0.10 μm inclusive, and a ten-spot average roughness Rz_{JIS94} of 0.02 to 0.05 μm inclusive.

The substrate may be a film or a sheet.

The center-line average roughness may be the center-line average roughness Ra7.5 defined in the supplements to JIS B 0601 (the center-line average roughness Ra in the old JIS).

The maximum height may be the maximum height Rz defined in JIS B 0601 (the maximum height Ry in the old JIS).

The ten-spot average roughness may be the ten-spot average roughness Rz_{JIS94} defined in the supplements to JIS B 0601 (the ten-spot average roughness Rz in the old JIS).

The transparent conductive film according to the above aspect of the present invention has both higher conductivity and higher transparency.

More specifically, the surface of the conductive layer has a center-line average roughness (Ra₇₅) within a range of 0.002 to 0.02 μm inclusive, a maximum height (Rz) within a range of 0.03 to 0.10 μm inclusive, and a ten-spot average roughness (Rz_{JIS94}) within a range of 0.02 to 0.05 μm inclusive. The transparent conductive film includes the conductive layer with a smooth surface, and thus reduces variations in the resistance that can be caused by surface roughness. The conductive layer in the transparent conductive film can be uniform and have lower resistance in a stable manner.

The transparent conductive film including the conductive layer with such a smooth surface reduces glare caused by diffuse reflection of light, and thus has high transparency.

If any one of the center-line average roughness (Ra7.5), the maximum height (Rz), and the ten-spot average roughness (Rz_{JIS94}) fails to fall within the above-specified extremely narrow ranges, the conductive layer in the transparent conductive film will have a less smooth surface. In this case, the transparent conductive film may not have both high conductivity and high transparency.

In detail, when the center-line average roughness (Ra₇₅) is less than 0.002 μm, the maximum height (Rz) is less than 0.03 μm, or the ten-spot average roughness (Rz_{JIS94}) is less than 0.02 μm, the conductive layer can be smooth but is more difficult to form. This may increase the number of man-hours or the cost for forming the conductive layer.

When the center-line average roughness (Ra₇₅) is greater than 0.02 μm, the maximum height (Rz) is greater than 0.10 μm, or the ten-spot average roughness (Rz_{JIS94}) is greater than 0.05 μm, the conductive layer can have a less smooth surface. The transparent conductive film may not have both high conductivity and high transparency. In one or more embodiments, the center-line average roughness (Ra₇₅) is within a range of 0.002 to 0.02 μm inclusive, the maximum height (Rz) is within a range of 0.03 to 0.10 μm inclusive, and the ten-spot average roughness (Rz_{JIS94}) is within a range of 0.02 to 0.05 μm inclusive.

The transparent conductive film is optimal when the center-line average roughness (Ra₇₅), the maximum height (Rz), and the ten-spot average roughness (Rz_{JIS94}) all fall within the respective extremely narrow ranges. In this case, the transparent conductive film has both higher conductivity and higher transparency.

In another aspect of the present invention, the conductive layer contains not less than 30% of polythiophene resin including conductive particles with an average particle diameter of 20 to 60 nm inclusive in a 90% interval for a standard deviation.

The polythiophene resin may be PEDOT:PSS having conductivity.

The transparent conductive film according to the above aspect of the present invention includes the conductive layer with at least a predetermined proportion of conductive particles having a small diameter, and thus has high conductivity in a more stable manner.

When the average particle diameter is less than 20 nm, the conductive layer is less likely to have a lower surface resistivity. Further, the crushing into intended particle diameters by applying energy such as ultrasonic waves would be more difficult, and take a longer time. As a result, the conductive layer may not be formed efficiently.

When the average particle diameter is greater than 60 nm, the conductive layer may not have the center-line average roughness (Ra₇₅), the maximum height (Rz), and/or the ten-spot average roughness (Rz_{JIS94}) falling within the above-specified extremely narrow ranges. Thus, the average particle diameter is 20 to 60 nm inclusive in one or more embodiments.

The transparent conductive film can have high conductivity in a more stable manner by regulating the particle diameter and the content of conductive particles in the conductive layer in minute scales.

In another aspect of the present invention, the conductive layer containing the polythiophene resin has a thickness of 100 to 500 nm inclusive.

The transparent conductive film according to the above aspect of the present invention can reduce variations in the cross-sectional area of the conductive layer by regulating the thickness of the conductive layer, and thus can reduce variations in the resistance. The conductive layer in the transparent conductive film can be uniform and have lower resistance in a stable manner.

The conductive layer with a thickness less than 100 nm is more difficult to form, and is likely to have lower strength. The conductive layer having a thickness greater than 500 nm can have lower transparency. Additionally, the transparent conductive film can be thick and thus have lower flexibility.

The transparent conductive film may crack to degrade conductivity when, for example, the film is rolled to cover an object. Thus, the conductive layer has a thickness of 100 to 500 nm inclusive in one or more embodiments.

The transparent conductive film can have high conductivity in a more stable manner by regulating the thickness of the conductive layer within the narrow range.

In another aspect of the present invention, the conductive layer containing the polythiophene resin has a surface resistivity of 50 to 400 Ω/sq inclusive.

The transparent conductive film according to the above aspect of the present invention can have high conductivity in a more stable manner by regulating the surface resistivity of the conductive layer within the narrow range.

In another aspect of the present invention, the transparent conductive film has a light transmittance of 70 to 90% inclusive.

When this transparent conductive film is used in, for example, an organic EL display, the transparent conductive film according to the above aspect of the present invention can transmit more light from an emissive layer. The transparent conductive film enables high-quality images and videos to be viewed more clearly.

When the light transmittance is less than 70%, the transparency can be low, and thus the visibility can be low. When the light transmittance is more than 90%, the transparency can be high, but the transparent conductive film is more difficult to form and thus may not have an intended quality in a stable manner, and may increase the cost. Thus, the conductive layer has a light transmittance of 70 to 90% inclusive in one or more embodiments.

The transparent conductive film can have high conductivity and high transparency and also improve visibility by regulating the light transmittance within the narrow range.

In another aspect of the present invention, the substrate includes a synthetic resin thin film with transparency, and a transparent coating layer with transparency arranged at least on a surface of the resin thin film adjacent to the conductive layer. The transparent coating layer includes a leveling layer containing a leveling material, an adhesion enhancing layer containing an adhesion enhancer, or a curable resin layer.

The synthetic resin may be a resin with a light transmittance of not less than 80%. Examples of such resins include polyester resins, polycarbonate resins, transparent polyimide resins, and cycloolefin resins.

The curable resin layer may be formed from an acrylic resin or an epoxy resin.

The transparent conductive film according to the above aspect of the present invention can have high transparency in a more stable manner.

When the transparent conductive film includes a leveling layer, the substrate can have a smooth surface. The transparent conductive film can have higher transparency.

When the transparent conductive film includes an adhesion enhancing layer, the conductive layer has higher adhesion to the substrate. This structure prevents the conductive layer from separating from the substrate when the transparent conductive film is bent, and thus prevents the transparent conductive film from having lower transparency and having lower conductivity.

Further, the transparent conductive film including a curable resin layer prevents deposition of elements with a low molecular weight, such as oligomers, from the resin thin film when the substrate or the transparent conductive film is heated. The transparent conductive film can thus prevent the resin thin film from becoming cloudy due to oligomer deposition.

The transparent conductive film includes the substrate including the resin thin film and the transparent coating layer, and thus has both higher conductivity and higher transparency.

In another aspect of the present invention, the substrate has at least one surface thereof coated with a metal layer with transparency or a semimetal layer with transparency by vapor deposition or sputtering.

The metal layer or the semimetal layer may be a layer of metal or semimetal, a metal oxide layer or a semimetal oxide layer, or a metal nitride layer or a semimetal nitride layer.

The transparent conductive film according to the above aspect of the present invention can have higher gas barrier performance. In detail, the synthetic resin thin film can transmit water and oxygen more easily than a glass substrate. When the resin thin film is used to replace a glass substrate in, for example, an organic EL device, the substrate may have high gas barrier performance to prevent an emissive layer, which is easy to deteriorate in the presence of water and oxygen, from contacting water and oxygen.

The transparent conductive film includes a metal layer or a semimetal layer forming a gas barrier layer to prevent water and oxygen that has passed through the resin thin film from reaching the emissive layer.

The transparent conductive film thus has high conductivity and high transparency, and also has high gas barrier performance.

The transparent conductive film according to one or more embodiments of the present invention has both higher conductivity and higher transparency.

Other aspects and advantages of the invention will be apparent upon reading the following description, the drawings, and the claims.

### BRIEF DESCRIPTION OF THE DRAWINGS

FIG. 1 is a cross-sectional view of an organic EL device;

FIG. 2 is a cross-sectional view of a transparent conductive film;

FIG. 3 is an enlarged cross-sectional view showing the state of conductive particles in a conductive layer;

FIG. 4 is a cross-sectional view of another transparent conductive film; and

FIG. 5 is a cross-sectional view of another transparent conductive film.

### DETAILED DESCRIPTION

Embodiments of the present invention will now be described with reference to the drawings.

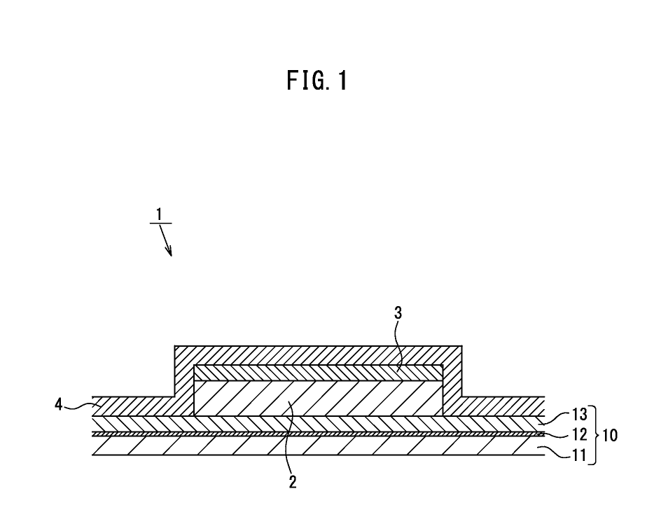

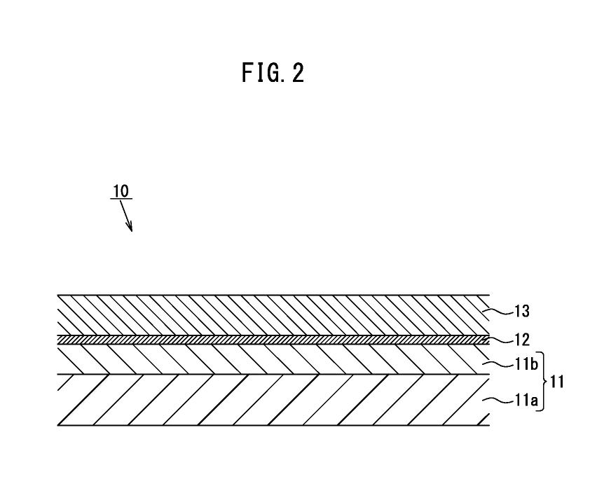

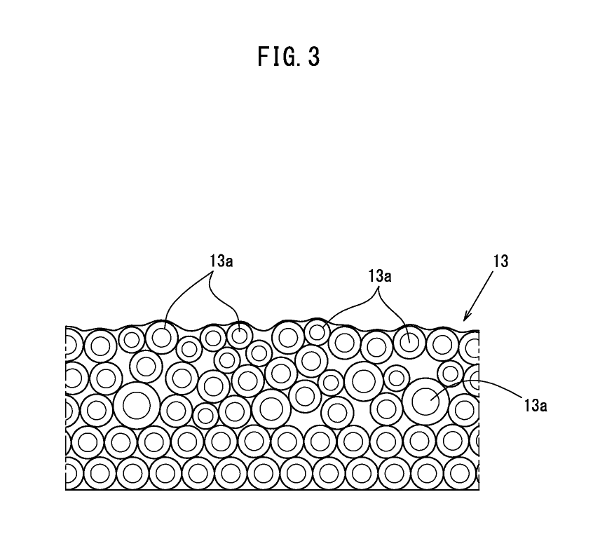

FIG. 1 is a cross-sectional view of an organic EL device 1. FIG. 2 is a cross-sectional view of a transparent conductive film 10. FIG. 3 is an enlarged cross-sectional view showing the state of conductive particles 13a in a conductive layer 13.

As shown in FIG. 1, the transparent conductive film 10 is used in, for example, a positive electrode and a substrate in the flexible organic EL device 1. More specifically, the organic EL device 1 includes an organic EL emissive layer 2, a negative electrode 3, and an encapsulating layer 4, which are arranged on one surface of the transparent conductive film 10 in the stated order. The organic EL emissive layer 2 includes a hole transport layer, an emissive layer, and an electron transport layer. The encapsulating layer 4 encapsulates the organic EL emissive layer 2 and the negative electrode 3.

The transparent conductive film 10 included in the organic EL device 1 is a flexible and conductive film formed to have a light transmittance falling within a range of 70 to 90% inclusive.

More specifically, as shown in FIG. 2, the transparent conductive film 10 includes a substrate 11, and a semimetal layer 12 and a conductive layer 13 arranged on the substrate 11 in the stated order.

The substrate 11 includes a synthetic resin thin film 11a, which is transparent and flexible, and a curable resin layer 11b, which is arranged on the surface of the resin thin film 11a adjacent to the conductive layer 13.

The resin thin film 11a is, for example, a PET film with a predetermined thickness, which is formed from a polyester resin. The resin thin film 11a is a thin film with a predetermined thickness. The resin thin film 11a may be formed from any synthetic resin material having transparency and flexibility. Examples of such synthetic resin materials further include polycarbonate resins, transparent polyimide resins, cycloolefin resins, acrylic resins, acetylcellulose resin, and fluorine resins.

The curable resin layer 11b is formed by applying an acrylic resin with a predetermined thickness to the resin thin film 11a. The curable resin layer 11b may be formed from any material that can prevent oligomer deposition from the resin thin film 11a. Examples of materials for the curable resin layer 1 lb further include urethane resins and epoxy resins. The curable resin layer 11b may be formed by, for example, coating using a coater, spraying, or spin coating, which is selected for the material of the curable resin layer 11b and the material of the resin thin film 11a.

The semimetal layer 12 is formed on the substrate 11 by vacuum vapor deposition or sputtering of a semimetal oxide.

The conductive layer 13 is formed on the semimetal layer 12 using a conductive resin containing not less than 30% of polythiophene resin including conductive particles with an average particle diameter of 20 to 60 nm inclusive in a 90% interval for the standard deviation. The conductive layer 13 has a thickness within a range of 100 to 500 nm inclusive.

The conductive layer 13 has a surface having a center-line average roughness Ra₇₅ within a range of 0.002 to 0.02 μm inclusive, a maximum height Rz within a range of 0.03 to 0.10 μm inclusive, and a ten-spot average roughness Rz_{JIS94} within a range of 0.02 to 0.05 μm inclusive, and a surface resistivity within a range of 50 to 400 Ω/sq inclusive. The center-line average roughness Ra₇₅, the maximum height Rz, and the ten-spot average roughness Rz_{JIS94} of the surface of the conductive layer 13 comply with JIS B 0601.

The conductive layer 13 may be formed using the above conductive resin with any method that can regulate the center-line average roughness Ra₇₅, the maximum height Rz, the ten-spot average roughness Rz_{JIS94}, the surface resistivity, and the thickness.

For example, the conductive layer 13 may be formed by applying a liquid for forming a conductive layer onto the semimetal layer 12 and drying the applied liquid. In this case, the liquid for forming a conductive layer may be a commercially available aqueous PEDOT:PSS dispersion containing poly(3,4-ethylenedioxythiophene) polystyrene sulfonate (PEDOT:PSS).

More specifically, the aqueous PEDOT:PSS dispersion, which contains poly(3,4-ethylenedioxythiophene) (PEDOT) and polystyrene sulfonate (PSS) as a dopant to increase solubility, is placed under energy such as ultrasonic waves to crush particles or condensed matter in the dispersion. Ion-exchange water is then added to the dispersion.

Subsequently, the aqueous PEDOT:PSS dispersion is centrifuged or filtered to remove particles with diameters larger than intended diameters and condensed matter. Alcohol dissolving a polyester aqueous binder is then added to the dispersion, which is then stirred for mixing. The resultant mixture of the aqueous PEDOT:PSS dispersion and alcohol is then filtered to remove particles with diameters larger than intended diameters and condensed matter. This yields a liquid to be applied to form a conductive layer.

The liquid for forming a conductive layer is then applied onto the semimetal layer 12, which is formed on the substrate 11. The applied liquid is then dried by heating at an appropriate temperature. This forms the conductive layer 13 with a thickness of 100 to 500 nm inclusive. As in the example shown in FIG. 3, the resultant conductive layer 13 has an irregular surface due to the conductive particles 13a with intended particle diameters.

As described above, the surface irregularity of the conductive layer 13 is regulated to satisfy the center-line average roughness Ra₇₅ within a range of 0.002 to 0.02 μm inclusive, the maximum height Rz within a range of 0.03 to 0.10 μm inclusive, and the ten-spot average roughness Rz_{JIS94} within a range of 0.02 to 0.05 μm inclusive. The surface of the conductive layer 13 may be polished with an appropriate method to achieve the intended values of the center-line average roughness Ra₇₅, the maximum height Rz, the ten-spot average roughness Rz_{JIS94}, and the thickness.

Table 1 shows the results for transparent conductive films 10 of examples 1 to 5 of the present invention and comparative examples 1 to 5. In examples 1 to 5 and comparative examples 1 to 5, the center-line average roughness Ra₇₅, the maximum height Rz, and the ten-spot average roughness Rz_{JIS94} were measured using the 3D laser scanning microscope VK-X100/X200 (KEYENCE CORPORATION) at a magnification of 12,000 to 2,400.

In the column shown overall rating in Table 1, B (good) indicates high conductivity and high transparency, and indicates that the conductive layer has a surface resistivity of 50 to 400 Ω/sq inclusive and the transparent conductive film has a light transmittance of 70 to 90% inclusive. In particular, A (very good) indicates higher conductivity and higher transparency, and indicates that the conductive layer has a surface resistivity of 50 to 150 Ω/sq inclusive and the transparent conductive film has a light transmittance of 85 to 90% inclusive.

The rating C (fair) indicates that the surface resistivity and the light transmittance are within the same ranges as for the rating B, but any one of the average particle diameter of conductive particles in a 90% interval for the standard deviation, the content of polythiophene resin, the thickness of the conductive layer, the center-line average roughness (Ra₇₅), the maximum height (Rz), and the ten-spot average roughness (Rz_{JIS94}) of the conductive layer has a value that may be inappropriate for practical use.

The rating D (poor) indicates that the conductive layer fails to have the surface resistivity of 50 to 400 Ω/sq inclusive and/or the transparent conductive film fails to have the light transmittance of 70 to 90% inclusive.

TABLE 1

| | Conductive Layer | | | Surface Roughness of | | | Transparent | | |
|---|---|---|---|---|---|---|---|---|---|
| | D90 | | | Conductive Layer | | | Conductive | | |
| | Average | | | Center-line | Maximum | Ten-spot | Film | | |
| | Particle | | | Average | Height | Average | Surface | Light | |
| | Diameter | Content | Thickness | Roughness | Rz | Roughness | Resistivity | Transmittance | Overall |
| | (nm) | (%) | (nm) | Ra₇₅ (μm) | (μm) | RZ_{JIS94} (μm) | (Ω/sq) | (%) | Rating* |
| Example 1 | 40 | 60 | 250 | 0.015 | 0.06 | 0.05 | 85 | 90 | A |
| Example 2 | 40 | 40 | 350 | 0.006 | 0.04 | 0.03 | 130 | 87 | A |
| Example 3 | 50 | 60 | 275 | 0.019 | 0.09 | 0.05 | 200 | 87 | B |
| Example 4 | 50 | 40 | 400 | 0.020 | 0.05 | 0.02 | 150 | 85 | B |
| Example 5 | 30 | 50 | 200 | 0.007 | 0.04 | 0.02 | 160 | 88 | B |
| Comparative | 80 | 50 | 250 | 0.029 | 0.17 | 0.05 | 480 | 80 | D |
| Example 1 | | | | | | | | | |
| Comparative | 80 | 70 | 200 | 0.060 | 0.19 | 0.10 | 240 | 68 | D |
| Example 2 | | | | | | | | | |
| Comparative | 60 | 60 | 95 | 0.025 | 0.12 | 0.04 | 650 | 88 | D |
| Example 3 | | | | | | | | | |
| Comparative | 40 | 25 | 530 | 0.009 | 0.08 | 0.07 | 320 | 81 | C |
| Example 4 | | | | | | | | | |
| Comparative | 30 | 30 | 350 | 0.005 | 0.03 | 0.01 | 760 | 91 | D |
| Example 5 | | | | | | | | | |

*A: very good, B: good, C: fair, D: poor

The transparent conductive film 10 in each of examples 1 to 5 in Table 1 has a light transmittance within a range of 70 to 90% inclusive, and includes a conductive layer 13 formed from a conductive resin containing not less than 30% of polythiophene resin including conductive particles with an average particle diameter of 20 to 60 nm inclusive in a 90% interval for the standard deviation. The conductive layer 13 also has a thickness within a range of 100 to 500 nm inclusive, a center-line average roughness Ra₇₅ within a range of 0.002 to 0.02 μm inclusive, a maximum height Rz within a range of 0.03 to 0.10 μm inclusive, a ten-spot average roughness Rz_{JIS94} within a range of 0.02 to 0.05 μm inclusive, and a surface resistivity within a range of 50 to 400 Ω/sq inclusive.

The transparent conductive film in each of comparative examples 1 to 5 shown in Table 1 includes a conductive layer formed from a polythiophene resin including conductive particles. The conductive layer in each of the comparative examples varies in the average particle diameter in a 90% interval for the standard deviation, the content of polythiophene resin, the thickness, the center-line average roughness Ra₇₅, the maximum height Rz, and the ten-spot average roughness Rz_{JIS94}.

More specifically, the transparent conductive film in each of comparative examples 1 and 2 includes a conductive layer formed from a polythiophene resin including conductive particles with an average particle diameter greater than 60 nm, and has a thickness of 100 to 500 nm inclusive. This conductive layer has at least a large center-line average roughness Ra₇₅ and a large maximum height Rz, and thus has a rough surface. As a result, the transparent conductive film has large surface resistivity or low light transmittance.

In comparative example 3, the transparent conductive film includes a conductive layer formed from a conductive resin containing not less than 30% of polythiophene resin including conductive particles with an average particle diameter of 20 to 60 nm inclusive, and has a thickness of less than 100 nm. The transparent conductive film has large surface resistivity and low conductivity, although it has relatively high light transmittance with respect to the center-line average roughness Ra₇₅ and the maximum height Rz of the conductive layer.

In comparative example 4, the transparent conductive film includes a conductive layer formed from a conductive resin containing less than 30% of polythiophene resin including conductive particles with an average particle diameter of 20 to 60 nm inclusive. This conductive layer has a thickness greater than 500 nm and a ten-spot average roughness Rz_{JIS94} greater than 0.05 μm. The transparent conductive film has a relatively high surface resistivity of 50 to 400 Ω/sq inclusive and a relatively high light transmittance of 70 to 90% inclusive.

However, the transparent conductive film of comparative example 4 is thick and has low flexibility. This transparent conductive film may crack when it is bent.

In comparative example 5, the transparent conductive film includes a conductive layer formed from a conductive resin containing not less than 30% of polythiophene resin including conductive particles with an average particle diameter of 20 to 60 nm inclusive. This conductive layer has a thickness within a range of 100 to 500 nm inclusive, a center-line average roughness Ra₇₅ within a range of 0.002 to 0.02 μm inclusive, a maximum height Rz within a range of 0.03 to 0.10 μm inclusive, and a ten-spot average roughness Rz_{JIS94} within a range of 0.02 to 0.05 μm inclusive. The transparent conductive film has relatively high light transmittance. However, the transparent conductive film has large surface resistivity, and thus has low conductivity.

The results in examples 1 to 5 and comparative examples 1 to 5 reveal that the transparent conductive film 10 has high light transmittance in a stable manner when the conductive layer 13 is formed from a conductive resin containing not less than 30% of polythiophene resin including conductive particles with an average particle diameter of 20 to 60 nm inclusive in a 90% interval for the standard deviation, and the thickness, the center-line average roughness Ra₇₅, the maximum height Rz, the ten-spot average roughness Rz_{JIS94}, and the surface resistivity fall within the specified ranges, unlike in comparative examples 1 to 5. In other words, the transparent conductive films 10 of examples 1 to 5 have higher transparency and higher conductivity than the conductive films of comparative examples 1 to 5.

In particular, the transparent conductive films 10 of examples 1 and 2 have extremely high transparency and conductivity. This reveals that the conductive layer may have a thickness within a range of 250 to 350 nm inclusive and be formed from a conductive resin containing 40 to 60% inclusive of polythiophene resin including conductive particles with an average particle diameter of about 40 nm in a 90% interval for the standard deviation. When the conductive layer has a center-line average roughness Ra₇₅ within a range of 0.002 to 0.02 μm inclusive, a maximum height Rz within a range of 0.03 to 0.10 μm inclusive, and a ten-spot average roughness Rz_{JIS}94 within a range of 0.02 to 0.05 μm inclusive, the transparent conductive film 10 can have a high surface resistivity of 50 to 150 Ω/sq inclusive and a high light transmittance of 85 to 90% inclusive.

The transparent conductive film 10 with the above-described structure has both higher conductivity and higher transparency.

More specifically, the surface of the conductive layer 13 has the center-line average roughness Ra₇₅ within a range of 0.002 to 0.02 μm inclusive, a maximum height Rz within a range of 0.03 to 0.10 μm inclusive, and a ten-spot average roughness Rz_{JIS94} within a range of 0.02 to 0.05 μm inclusive. The transparent conductive film 10 includes the conductive layer with a smooth surface, and thus reduces variations in the resistance that can be caused by surface roughness. The conductive layer 13 in the transparent conductive film 10 can be uniform and have lower resistance in a stable manner.

The transparent conductive film 10 including the conductive layer 13 with such a smooth surface reduces glare caused by diffuse reflection of light, and thus has high transparency. If any one of the center-line average roughness Ra₇₅, the maximum height Rz, and the ten-spot average roughness Rz_{JIS94} fails to fall within the above-specified extremely narrow ranges, the conductive layer 13 in the transparent conductive film 10 will have a less smooth surface. In this case, the transparent conductive film 10 may not have both high conductivity and high transparency.

The transparent conductive film 10 is optimal when the center-line average roughness Ra₇₅, the maximum height Rz, and the ten-spot average roughness Rz_{JIS94} all fall within the above-specified extremely narrow ranges. In this case, the transparent conductive film 10 has both higher conductivity and higher transparency.

The conductive layer 13 contains not less than 30% of polythiophene resin with an average particle diameter of 20 to 60 nm inclusive in a 90% interval for the standard deviation. The transparent conductive film 10 includes the conductive layer 13 with at least a predetermined proportion of conductive particles having a small diameter, and thus has high conductivity in a more stable manner.

In one or more embodiments, the conductive layer 13 may contain 40 to 60% inclusive of polythiophene resin with an average particle diameter of about 40 nm in a 90% interval for the standard deviation to provide higher transparency and higher conductivity.

The transparent conductive film 10 can have high conductivity in a more stable manner by regulating the average particle diameter and the content of conductive particles in the conductive layer 13 in minute scales.

The transparent conductive film 10 including the conductive layer 13 with a thickness of 100 to 500 nm inclusive can reduce variations in the cross-sectional area of the conductive layer 13 by regulating the thickness of the conductive layer 13, and thus can reduce variations in the resistance. The conductive layer 13 in the transparent conductive film 10 can be uniform and have lower resistance in a stable manner.

In one or more embodiments, the conductive layer 13 has a thickness of 250 to 350 nm inclusive, and thus achieves higher transparency and higher conductivity.

The transparent conductive film 10 can have high conductivity in a more stable manner by regulating the thickness of the conductive layer 13 within the narrow range.

The transparent conductive film 10 can have high conductivity in a more stable manner by regulating the surface resistivity of the conductive layer 13 in the narrow range of 50 to 400 Ω/sq inclusive.

The transparent conductive film 10 has a light transmittance of 70 to 90% inclusive. When this transparent conductive film 10 is used in, for example, an organic EL display, the transparent conductive film 10 can transmit more light from an organic EL emissive layer 2. The transparent conductive film 10 enables high-quality images and videos to be viewed more clearly.

The transparent conductive film 10 can have high conductivity and high transparency and also improve visibility by regulating the light transmittance within the narrow range.

The substrate 11 includes the resin thin film 11a and the curable resin layer 11b. The transparent conductive film 10 can thus prevent deposition of elements with a low molecular weight, such as oligomers, from the resin thin film 11a when the substrate 11 or the transparent conductive film 10 is heated. The transparent conductive film 10 can thus prevent the resin thin film 11a from becoming cloudy due to oligomer deposition.

The transparent conductive film 10 includes the substrate 11 including the resin thin film 11a and the curable resin layer 11b, and thus has both higher conductivity and higher transparency.

The semimetal layer 12 is formed on the surface of the substrate 11 adjacent to the conductive layer 13. The transparent conductive film 10 can thus have higher gas barrier performance. In detail, the synthetic resin thin film 11a can transmit water and oxygen more easily than a glass substrate. When the resin thin film is used to replace a glass substrate in, for example, an organic EL device 1, the substrate 11 needs to improve its gas barrier performance to prevent the emissive layer 2, which is easy to deteriorate in the presence of water and oxygen, from contacting water and oxygen.

The transparent conductive film 10 includes the semimetal layer forming a gas barrier layer to prevent water and oxygen that has passed through the resin thin film 11a from reaching the organic EL emissive layer 2.

The transparent conductive film 10 thus has high conductivity and high transparency, and also has high gas barrier performance.

Although the semimetal layer 12 is formed on the surface of the substrate 11 adjacent to the conductive layer 13 in the above embodiments, the embodiments are not limited to this structure. In one or more embodiments, the surface of the substrate 11 adjacent to the conductive layer 13 may be coated with another semimetal layer, or a semimetal nitride layer, a metal or metal oxide layer, or a metal nitride layer. In one or more embodiments, the surface of the resin thin film 11a opposite to the surface adjacent to the conductive layer 13 may be coated with a metal layer or a semimetal layer. Such metal layers or semimetal layers may be eliminated depending on the usage of the transparent conductive film 10.

Although the substrate 11 includes the resin thin film 11a and the curable resin layer 11b, the substrate 11 may simply include the resin thin film 11a.

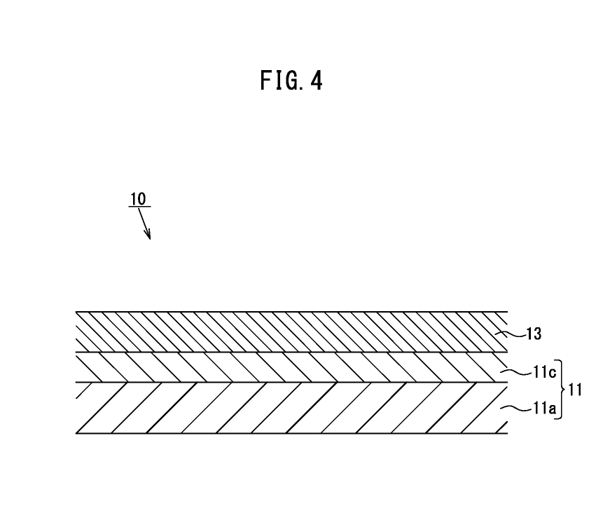

FIG. 4 is a cross-sectional view of another transparent conductive film 10. As shown in the figure, a substrate 11 may include a resin thin film 11a and a leveling layer 11c containing a leveling material. In this case, the substrate 11 can have a smooth surface. The transparent conductive film 10 can thus have higher transparency.

The leveling layer 11c shown in FIG. 4 may be replaced with an adhesion enhancing layer containing an adhesion enhancer. This structure enhances the adhesion of the conductive layer 13 to the substrate 11. This structure prevents the conductive layer 13 from separating from the substrate 11 when the transparent conductive film 10 is bent, and prevents the transparent conductive film 10 from having lower transparency and lower conductivity.

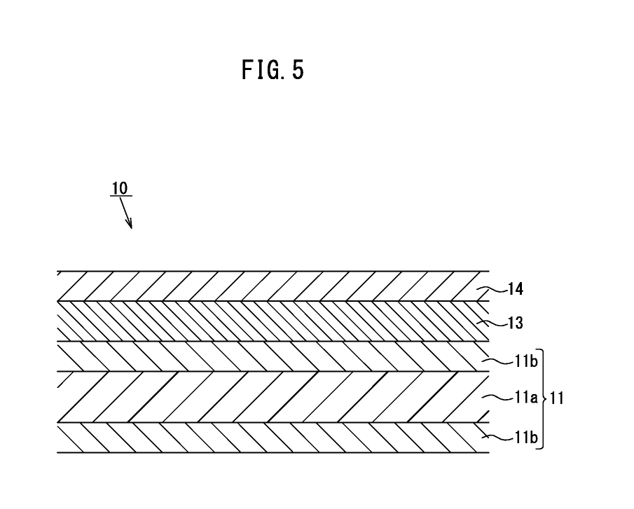

Although the curable resin layer 11b is formed on the surface of the resin thin film 11a adjacent to the conductive layer 13, the embodiments are not limited to this structure. FIG. 5 is a cross-sectional view of another transparent conductive film 10. As shown in the figure, a substrate 11 may include a resin thin film 11a sandwiched by two curable resin layers 11b. This structure prevents oligomer deposition from the resin thin film 11a caused by heating in a more reliable manner. The transparent conductive film 10 thus has higher transparency.

As shown in FIG. 5, the transparent conductive film 10 may further include a curable resin layer 14 on the conductive layer 13. In other words, the conductive layer 13 is sandwiched by the curable resin layers 11b and 14. The transparent conductive film 10 with this structure prevents oligomer deposition from the resin thin film 11a and has higher wear resistance and higher scratch resistance.

Although the transparent coating layer according to one or more aspects of the present invention corresponds to the leveling layer 11c, the adhesion enhancing layer, and the curable resin layer 11b described in the above embodiments, the present invention should not be limited to the structures described in the above embodiments, and may be implemented in many other embodiments.

### INDUSTRIAL APPLICABILITY

The transparent conductive film according to one or more embodiments of the present invention is usable in touch panels, organic EL displays, solar panels, and LED illuminations.

### REFERENCE SIGNS LIST

10 transparent conductive film

11 substrate

11a resin film

11b curable resin layer

11c leveling layer

12 semimetal layer

13 conductive layer

13a conductive particles

1. A transparent conductive film, comprising:
a substrate with transparency and flexibility; and
a conductive layer arranged on at least one surface of the substrate, the conductive layer comprising a conductive resin,
wherein the conductive layer has a surface with a center-line average roughness Ra₇₅ of 0.002 to 0.02 μm inclusive, a maximum height Rz of 0.03 to 0.10 μm inclusive, and a ten-spot average roughness Rz_{JIS94} of 0.02 to 0.05 μm inclusive.

2. The transparent conductive film according to claim 1, wherein
the conductive layer contains not less than 30% of polythiophene resin including conductive particles with an average particle diameter of 20 to 60 nm inclusive in a 90% interval for a standard deviation.

3. The transparent conductive film according to claim 2, wherein
the conductive layer containing the polythiophene resin has a thickness of 100 to 500 nm inclusive.

4. The transparent conductive film according to claim 2, wherein
the conductive layer containing the polythiophene resin has a surface resistivity of 50 to 400 Ω/sq inclusive.

5. The transparent conductive film according to claim 1, wherein
the transparent conductive film has a light transmittance of 70 to 90% inclusive.

6. The transparent conductive film according to claim 1, wherein
the substrate comprises a synthetic resin thin film with transparency, and a transparent coating layer with transparency arranged at least on a surface of the resin thin film adjacent to the conductive layer, and
the transparent coating layer comprises a leveling layer containing a leveling material, an adhesion enhancing layer containing an adhesion enhancer, or a curable resin layer.

7. The transparent conductive film according to claim 1, wherein
the substrate has at least one surface thereof coated with a metal layer with transparency or a semimetal layer with transparency by vapor deposition or sputtering.

8. The transparent conductive film according to claim 3, wherein
the conductive layer containing the polythiophene resin has a surface resistivity of 50 to 400 Ω/sq inclusive.
